(19) United States
(12) Patent Application Publication
(10) Pub. No.: US 2025/0121783 A1
(43) Pub. Date: Apr. 17, 2025

(54) MANAGEMENT DEVICE, NON-TRANSITORY COMPUTER-READABLE STORAGE MEDIUM STORING CONTROL PROGRAM, AND CONTROL METHOD

(71) Applicant: TOYOTA JIDOSHA KABUSHIKI KAISHA, Toyota-shi (JP)

(72) Inventors: Daisuke TAKAISHI, Anjo-shi (JP); Kazuya SUGIYAMA, Nisshin-shi (JP); Hiroya ANDOU, Toyota-shi (JP)

(73) Assignee: TOYOTA JIDOSHA KABUSHIKI KAISHA, Toyota-shi (JP)

(21) Appl. No.: 18/887,095

(22) Filed: Sep. 17, 2024

(30) Foreign Application Priority Data
Oct. 12, 2023 (JP) 2023-176733

(51) Int. Cl. B60R 16/023

(52) U.S. Cl. CPC B60R 16/0231

(57) ABSTRACT

A management device is applied to an in-vehicle network system including electronic control units. When a vehicle is in a first state, the management device supplies power to one of the electronic control units included in a first group, and does not supply power to another one of the electronic control units not included in the first group. When the vehicle is in a second state differing from the first state, the management device supplies power to one of the electronic control units included in a second group differing from the first group, and does not supply power to another one of the electronic control units not included in the second group.

### CROSS-REFERENCE TO RELATED APPLICATIONS

This application is based upon and claims the benefit of priority from prior Japanese Patent Application No. 2023-176733, filed on Oct. 12, 2023, the entire contents of which are incorporated herein by reference.

### BACKGROUND

### 1. Field

The following description relates to a management device, a non-transitory computer-readable storage medium storing a control program, and a control method.

### 2. Description of Related Art

Japanese Laid-Open Patent Publication No. 2021-011228 discloses an in-vehicle network system, which is a network system for a vehicle. The in-vehicle network system includes electronic control units that execute processes while communicating with one another to implement specific functions, and a management device that activates the electronic control units. The management device activates the electronic control units by requesting activation through communication.

In such an in-vehicle network system, the management device supplies power to the electronic control units so as to implement the specific functions. Thus, electric power consumption increases with the number of electronic control units supplied with power.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a management device of a network system for a vehicle is provided. The network system includes electronic control units that form groups. The groups each include at least one of the electronic control units. The groups include a first group and a second group. The first group differs from the second group. When a state of the vehicle is a first state, the management device is configured to supply power to the at least one of the electronic control units included in the first group, and not supply power to one or more of the electronic control units not included in the first group. When the state of the vehicle is a second state differing from the first state, the management device is configured to supply power to the at least one of the electronic control units included in the second group, and not supply power to one or more of the electronic control units not included in the second group.

In another general aspect, a non-transitory computer readable storage medium storing a control program is provided. The control program is configured to be executed by a management device of a network system for a vehicle. The network system includes electronic control units that form groups. The groups each include at least one of the electronic control units. The groups include a first group and a second group. The first group differs from the second group. When a state of the vehicle is a first state, the control program executed by the management device is configured to cause the management device to supply power to the at least one of the electronic control units included in the first group, and not supply power to one or more of the electronic control units not included in the first group. When the state of the vehicle is a second state differing from the first state, the control program executed by the management device is configured to cause the management device to supply power to the at least one of the electronic control units included in the second group, and not supply power to one or more of the electronic control units not included in the second group.

In a further general aspect, a method for controlling a network system for a vehicle is provided. The network system includes electronic control units that form groups. The groups each include at least one of the electronic control units. The groups include a first group and a second group. The first group differs from the second group. When a state of the vehicle is a first state, the method includes supplying power, with the management device, to the at least one of the electronic control units included in the first group; and not supplying power, with the management device, to one or more of the electronic control units not included in the first group. When the state of the vehicle is a second state differing from the first state, the control method includes supplying power, with the management device, to the at least one of the electronic control units included in the second group; and not supplying power, with the management device, to one or more of the electronic control units not included in the second group.

Other features and aspects will be apparent from the following detailed description, the drawings, and the claims.

### BRIEF DESCRIPTION OF THE DRAWINGS

FIG. 1 is a schematic diagram showing the configuration of an in-vehicle network system including a management device in accordance with an embodiment.

FIG. 2 is a table showing the relationship of electronic control units supplied with power in accordance with a state of a vehicle, groups of the electronic control units, and clusters of the electronic control units in the in-vehicle network system of the embodiment.

FIG. 3 is a Venn diagram showing the relationship of the groups, the clusters, and the electronic control units in the in-vehicle network system of the embodiment.

FIG. 4 is a flowchart of a process executed by the management device to supply power to an electronic control unit.

FIG. 5 is a flowchart of a process executed by the management device to activate an electronic control unit in a group.

FIG. 6 is a flowchart of a process executed by the management device to shift an electronic control unit in a group to a standby state.

FIG. 7 is a schematic diagram illustrating a first case example of a configuration in which the management device activates an electronic control unit.

FIG. 8 is a schematic diagram illustrating a second case example of a configuration in which the management device activates an electronic control unit.

FIG. 9 is a schematic diagram illustrating a third case example of a configuration in which the management device activates an electronic control unit.

FIG. 10 is a schematic diagram illustrating a fourth case example of a configuration in which the management device supplies power to an electronic control unit.

FIG. 11 is a flowchart of a process executed by a management device of a modified example to supply power to an electronic control unit.

FIG. 12 is a flowchart of a process executed by the management device of the modified example on an electronic control unit in an operation state when a state of a vehicle is shifted.

FIG. 13 is a table showing the relationship of electronic control units supplied with power in accordance with a state of a vehicle, groups of the electronic control units, and clusters of the electronic control units in an in-vehicle network system of another modified example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

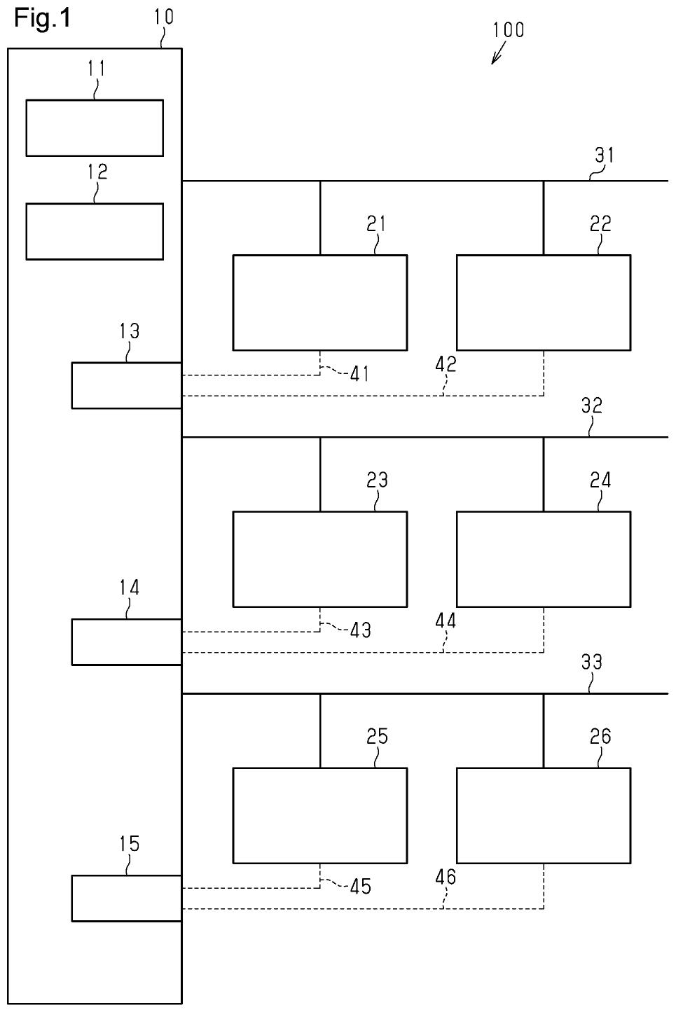

An embodiment of a management device will now be described with reference to FIGS. 1 to 10.

### Configuration of In-Vehicle Network System 100

As shown in FIG. 1, an in-vehicle network system 100, which is a network system for a vehicle, includes a management device 10 and electronic control units (ECUs). The electronic control units may each be denoted by “ECU” in the drawings.

The management device 10 includes a processing device 11 and a storage device 12. The storage device 12 stores programs. The programs stored in the storage device 12 include a control program that is related to supply of power to the electronic control units and activation of the electronic control units in the in-vehicle network system 100. The processing device 11 executes various processes by running the programs stored in the storage device 12. The processing device 11 includes a processor.

Each of the electronic control units may be in a deactivation state, a standby state, or an operation state. In the deactivation state, the electronic control unit is not supplied with power. In the standby state, the electronic control unit is supplied with power but is inactive so that electric power consumption is reduced. In the operation state, the electronic control unit is supplied with power and is permitted to perform processing.

The in-vehicle network system 100 includes the electronic control units, namely, a first ECU 21, a second ECU 22, a third ECU 23, a fourth ECU 24, a fifth ECU 25, and a sixth ECU 26.

As indicated by the broken lines in FIG. 1, the management device 10 is connected to the electronic control units by wires. The management device 10 is connected to the first ECU 21 by a first wire 41. The management device 10 is connected to the second ECU 22 by a second wire 42. The management device 10 is connected to the third ECU 23 by a third wire 43. The management device 10 is connected to the fourth ECU 24 by a fourth wire 44. The management device 10 is connected to the fifth ECU 25 by a fifth wire 45. The management device 10 is connected to the sixth ECU 26 by a sixth wire 46.

The management device 10 receives power from an electric power supply. The management device 10 supplies the power received from the electric power supply to the electronic control units through the wires. The management device 10 supplies power to the first ECU 21 through the first wire 41. The management device 10 supplies power to the second ECU 22 through the second wire 42. The management device 10 supplies power to the third ECU 23 through the third wire 43. The management device 10 supplies power to the fourth ECU 24 through the fourth wire 44. The management device 10 supplies power to the fifth ECU 25 through the fifth wire 45. The management device 10 supplies power to the sixth ECU 26 through the sixth wire 46.

The management device 10 includes a first relay unit 13, a second relay unit 14, and a third relay unit 15.

The first relay unit 13 is connected to the first wire 41 and the second wire 42. The first relay unit 13 controls the supply of power to the first ECU 21 and the second ECU 22. The first relay unit 13 closes a relay connected to the first wire 41 so as to supply power to the first ECU 21 through the first wire 41. The first relay unit 13 closes a relay connected to the second wire 42 so as to supply power to the second ECU 22 through the second wire 42.

The second relay unit 14 is connected to the third wire 43 and the fourth wire 44. The second relay unit 14 controls the supply of power to the third ECU 23 and the fourth ECU 24. The second relay unit 14 closes a relay connected to the third wire 43 so as to supply power to the third ECU 23 through the third wire 43. The second relay unit 14 closes a relay connected to the fourth wire 44 so as to supply power to the fourth ECU 24 through the fourth wire 44.

The third relay unit 15 is connected to the fifth wire 45 and the sixth wire 46. The third relay unit 15 controls the supply of power to the fifth ECU 25 and the sixth ECU 26. The third relay unit 15 closes a relay connected to the fifth wire 45 so as to supply power to the fifth ECU 25 through the fifth wire 45. The third relay unit 15 closes a relay connected to the sixth wire 46 so as to supply power to the sixth ECU 26 through the sixth wire 46.

In this manner, the management device 10 supplies power to a specified electronic control unit. The electronic control unit supplied with power shifts from the deactivation state to the standby state.

The management device 10 is connected to the electronic control units by communication lines. The management device 10 is connected to the first ECU 21 and the second ECU 22 by a first communication line 31. The management device 10 is connected to the third ECU 23 and the fourth ECU 24 by a second communication line 32. The management device 10 is connected to the fifth ECU 25 and the sixth ECU 26 by a third communication line 33.

The management device 10 sends messages through the communication lines. Each message includes a signal requesting activation and identification information of an electronic control unit that is determined as a recipient of the signal. Specifically, the management device 10 sends such a message to the first ECU 21 and the second ECU 22 through the first communication line 31. The management device 10 sends such a message to the third ECU 23 and the fourth ECU 24 through the second communication line 32. The management device 10 sends such a message to the fifth ECU 25 and the sixth ECU 26 through the third communication line 33.

An electronic control unit may receive a message from the management device 10 if the electronic control unit is in the standby state. As the electronic control unit receives a message from the management device 10, the electronic control unit checks the information included in the received message that indicates the recipient. If the subject electronic control unit is determined as the recipient of the message, the electronic control unit becomes activated in response to the received signal. That is, an electronic control unit in the standby state shifts from the standby state to the operation state upon receipt of a message addressed to the electronic control unit. However, if the subject control unit is determined as not the recipient of the message, the electronic control unit ignores the received signal. In this manner, the management device 10 activates only a specified electronic control unit by sending a message through a corresponding communication line.

The electronic control unit shifted to the operation state communicates with another electronic control unit that is also shifted to the operation state so that the electronic control units execute processes to implement a specific function. When the electronic control units implement the specific function, the vehicle is allowed to provide the function to a user.

While the specific function is being implemented by the electronic control units, each of the electronic control units sends a signal requesting continuation of operation to the management device 10 through a corresponding communication line in a cyclic manner. Then, when the vehicle finishes providing the function, the electronic control units stop sending the signals requesting continuation of operation.

As long as the management device 10 receives a signal requesting continuation of operation from an electronic control unit, the management device 10 sends a message including a signal requesting activation addressed to the electronic control unit in the operation state through a corresponding communication line. Then, when the management device 10 no longer receives the signal requesting continuation of operation from the electronic control unit, the management device 10 stops sending the message.

Whenever an electronic control unit, activated by the management device 10, receives a message including a signal requesting activation addressed to the electronic control unit from the management device 10 through a corresponding communication line, the electronic control unit continues to operate for a certain period of time. When the electronic control unit stops receiving the message including a signal requesting activation addressed to the electronic control unit from the management device 10 through the communication line, the electronic control unit executes a shifting process for stopping the operation and shifting to the standby state.

In the shifting process, the electronic control unit stores data to a memory. While the shifting process is being executed, the electronic control unit sends a signal indicating that the electronic control unit is executing the shifting process to the management device 10. This allows the management device 10 to recognize an electronic control unit that is executing the shifting process.

### Combination of Electronic Control Units Supplied with Power and Activated by Management Device 10

As described above, the management device 10 is configured to supply power to a specific electronic control unit through a corresponding wire. The management device 10 supplies power to an electronic control unit included in a group that corresponds to a state of the vehicle. A group is formed by a combination of electronic control units supplied with power by the management device 10 in accordance with the state of the vehicle. The state of the vehicle may include a state in which no group is supplied with power.

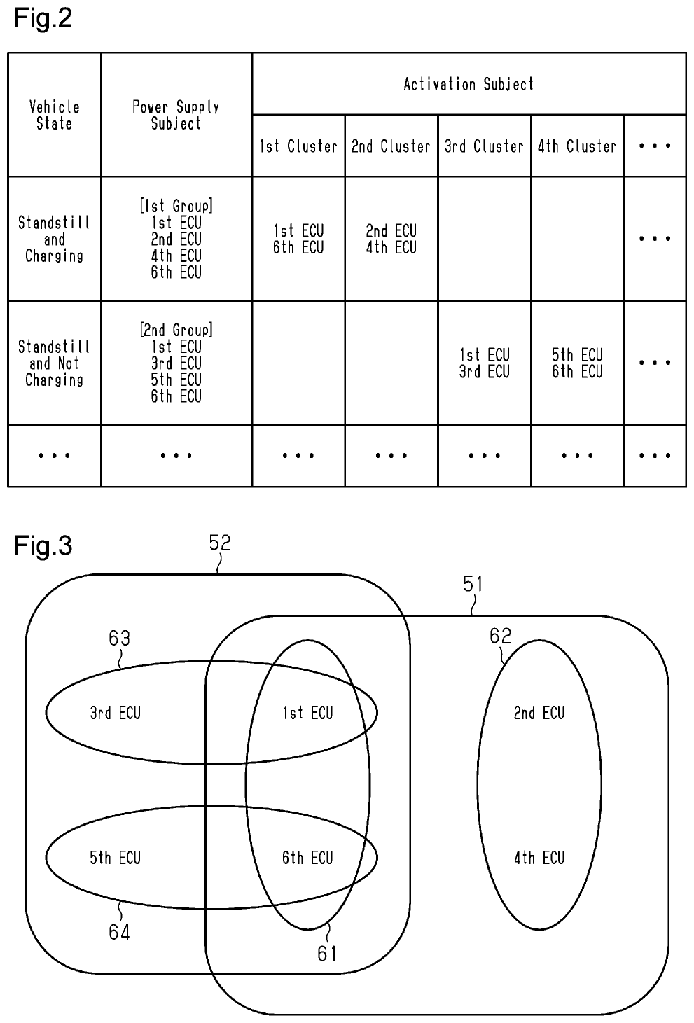

FIG. 2 is a table showing a relationship of the electronic control units supplied with power in accordance with the state of the vehicle, groups of the electronic control units, and clusters of the electronic control units.

As shown in FIG. 2, when the management device 10 determines that the vehicle is at a standstill and is being charged, the management device 10 supplies power to the first ECU 21, the second ECU 22, the fourth ECU 24, and the sixth ECU 26. Hereinafter, the state in which the vehicle is at a standstill and is being charged will be referred to as “first state”. Further, the group that is supplied with power when the management device 10 determines that the vehicle is in the first state will be referred to as “first group 51”.

As shown in FIG. 2, when the management device 10 determines that the vehicle is at a standstill and is not being charged, the management device 10 supplies power to the first ECU 21, the third ECU 23, the fifth ECU 25, and the sixth ECU 26. Hereinafter, the state in which the vehicle is at a standstill and is not being charged will be referred to as “second state”. Further, the group that is supplied with power when the management device 10 determines that the vehicle is in the second state will be referred to as “second group 52”.

As described above, an electronic control unit implements a specific function while communicating with another electronic control unit. In each group, electronic control units that shift to the operation state so that the vehicle provides a specific function form a cluster. That is, electronic control units included in a group form a cluster for each function.

The management device 10 receives a request for implementation of a specific function from another device. For example, the management device 10 receives a signal requesting the vehicle provide a specific function from an electronic control unit that is configured to detect a user operation and is connected to the management device 10 in a manner allowing for communication. In accordance with the specific function to be provided by the vehicle, the management device 10 activates electronic control units included in a group that are in a cluster, which implements the function.

As shown in FIGS. 2 and 3, the first ECU 21 and the sixth ECU 26 form a first cluster 61 in the first group 51. The first ECU 21 and the sixth ECU 26 implement a specific function in the first group 51 by communicating with each other. Further, as shown in FIGS. 2 and 3, the second ECU 22 and the fourth ECU 24 form a second cluster 62 in the first group 51. The second ECU 22 and the fourth ECU 24 implement another function, which is different from that of the first cluster 61, in the first group 51 by communicating with each other.

As shown in FIG. 1, the first ECU 21 is connected to the first communication line 31. Further, the sixth ECU 26 is connected to the third communication line 33. Thus, the first cluster 61 includes two ECUs that are connected to different communication lines. In this manner, a cluster may include multiple ECUs that are connected to different communication lines. Alternatively, a cluster may include multiple ECUs that are connected to the same communication line.

As shown in FIGS. 2 and 3, the first ECU 21 and the third ECU 23 form a third cluster 63 in the second group 52. The first ECU 21 and the third ECU 23 implement a specific function in the second group 52 by communicating with each other. Further, as shown in FIGS. 2 and 3, the fifth ECU 25 and the sixth ECU 26 form a fourth cluster 64 in the second group 52. The fifth ECU 25 and the sixth ECU 26 implement another function, which is different from that of the fourth cluster 64, in the second group 52 by communicating with each other.

As shown in FIG. 3, the first ECU 21 and the sixth ECU 26 are included in both the first group 51 and the second group 52. In this manner, an electronic control unit may be included in multiple groups. Also, an electronic control unit may belong to multiple clusters within the same group.

A cluster formed in a group implements a specific function that has a likelihood of being provided by the vehicle when the vehicle is in a state corresponding to the group. In other words, each group includes a cluster that corresponds to a specific function having a likelihood of being provided by the vehicle that is in a state corresponding to the group.

The management device 10 activates a cluster of electronic control units in a group in accordance with a function to be provided. On the other hand, the management device 10 will not activate a cluster that is outside the group corresponding to the state of the vehicle. As shown in FIG. 3, for example, when the vehicle is in the first state, the electronic control units in the fourth cluster 64 will not be activated.

### Flow of Process Executed by Processing Device 11 to Supply Power to Electronic Control Unit

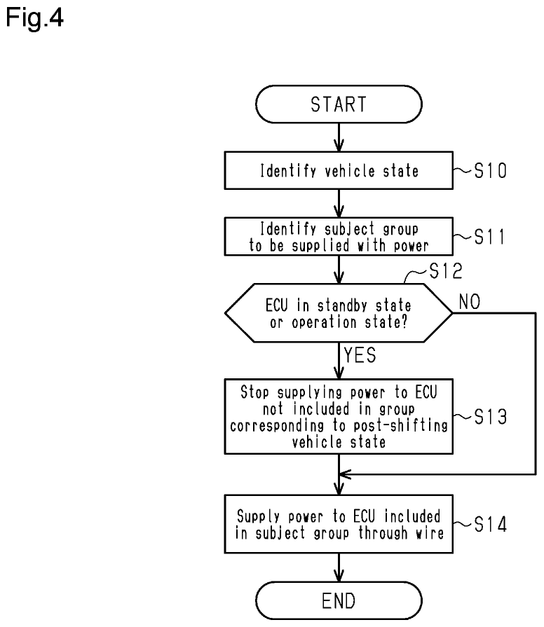

FIG. 4 shows a series of processes executed by the management device 10 to supply power to a group of electronic control units. The processing device 11 of the management device 10 executes the series of processes in accordance with the control program stored in the storage device 12.

The present series of processes is initiated when the management device 10 detects that the state of the vehicle is shifted. Specifically, as the management device 10 detects that a user inserted a charging plug into the vehicle at a standstill, the management device 10 detects that the vehicle is shifted from a state in which the vehicle is at a standstill and not being charged to a state in which the vehicle is at a standstill and being charged.

In step S10, the processing device 11 identifies the state of the vehicle. Specifically, the management device 10 determines the state of the vehicle by detecting whether the vehicle is at a standstill, whether a charging plug is inserted into the vehicle, or the like.

The management device 10 may detect a state of the vehicle that is determined by, for example, information indicating whether a user is inside the vehicle. The management device 10 may detect a state of the vehicle that is determined by, for example, whether a set amount of time has elapsed from when a user of the vehicle performed an operation.

In step S11, the processing device 11 identifies a subject group to be supplied with power. The storage device 12 stores data that links the states of the vehicle, the groups, and the clusters, such as that shown in FIG. 2. The processing device 11 refers to the data stored in the storage device 12 and identifies a group corresponding to the state of the vehicle as the subject group to be supplied with power.

In step S12, the processing device 11 determines whether there is any electronic control unit in the standby state or the operation state in the in-vehicle network system 100. The electronic control units included in a group corresponding to the pre-shifting state of the vehicle are in the standby state or the operation state.

When the processing device 11 determines that there is an electronic control unit in the standby state or the operation state in the in-vehicle network system 100 in step S12 (step S12: YES), the processing device 11 proceeds to step S13.

In step S13, the processing device 11 stops supplying power to an electronic control unit. Specifically, the processing device 11 stops supplying power to an electronic control unit that is included in a group corresponding to the pre-shifting state of the vehicle and is not included in a group corresponding to the post-shifting state of the vehicle. When the supply of power to such an electronic control unit is stopped, the electronic control unit shifts from the standby state or the operation state to the deactivation state. After completing step S13, the processing device 11 proceeds to step S14.

When the processing device 11 determines that there is no electronic control unit in the standby state or the operation state in the in-vehicle network system 100 in step S12 (step S12: NO), the processing device 11 proceeds to step S14. That is, when the processing device 11 determines that no electronic control unit is in the standby state or the operation state in the in-vehicle network system 100, the processing device 11 skips step S13. A case where there is no electronic control unit in the standby state or the operation state in the in-vehicle network system 100 includes, for example, a case where no subject group was supplied with power in the pre-shifting state of the vehicle.

In step S14, the processing device 11 supplies power to an electronic control unit through a corresponding wire. Specifically, the processing device 11 supplies power to an electronic control unit that is included in a group corresponding to the state of the vehicle, which was identified in step S11. The electronic control units included in a group corresponding to the post-shifting state of the vehicle were not deactivated in step S13. Therefore, in step S14, the management device 10 supplies power to an electronic control unit that is not being supplied with power and is included in a group corresponding to the post-shifting state of the vehicle. Alternatively, if no group corresponds to the post-shifting state of the vehicle, the processing device 11 does not supply power to any electronic control unit. When a subject electronic control unit is supplied with power, the processing device 11 ends the series of processes.

### Flow of Process Executed by Processing Device 11 to Activate Electronic Control Unit

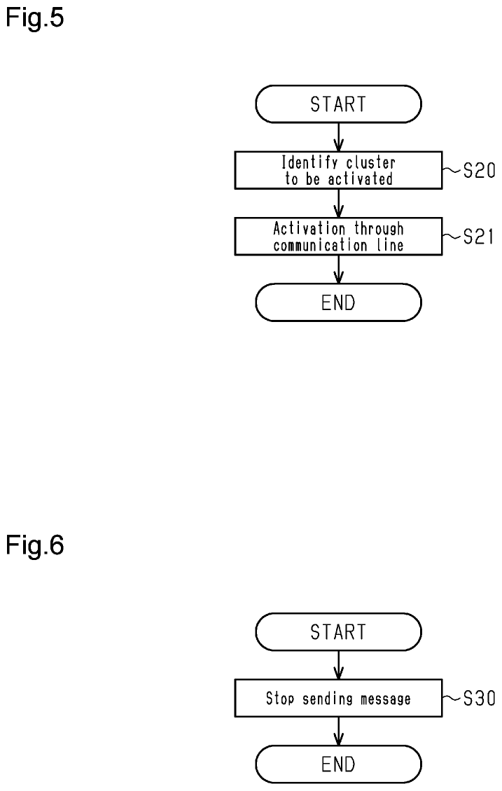

FIG. 5 shows a series of processes executed by the management device 10 to activate an electronic control unit included in a group, which is supplied with power in accordance with the flow shown in FIG. 4. The processing device 11 of the management device 10 executes the series of processes in accordance with the control program stored in the storage device 12. The present series of processes is initiated when the management device 10 receives a request for implementation of a specific function from a separate device.

In step S20, the processing device 11 identifies a cluster to be activated from the clusters included in a group in the standby state. In this case, the processing device 11 identifies a cluster that implements the specific function, which is requested by the separate device, as the cluster to be activated.

In step S21, the processing device 11 activates all of the electronic control units in the cluster identified in step S20. In this case, the processing device 11 sends a message addressed to each of the electronic control units to be activated through corresponding communication lines. Upon receipt of such messages, the electronic control units become activated and execute processes while communicating with one another in order to implement the specific function.

After activating the electronic control units, the processing device 11 ends the series of processes.

### Flow of Process Executed by Processing Device 11 to Shift Electronic Control Unit to Standby State

FIG. 6 shows a series of processes executed by the management device 10 to shift an electronic control unit, included in a cluster activated in accordance with the flow of FIG. 5, from the operation state to the standby state. The processing device 11 of the management device 10 executes the series of processes in accordance with the control program stored in the storage device 12.

As described above, while a specific function is being implemented by corresponding electronic control units, each of the electronic control units sends a signal requesting continuation of operation to the management device 10 in a cyclic manner. Further, as long as the management device 10 receives a signal requesting continuation of operation, the management device 10 sends a message to a corresponding electronic control unit in the operation state. The present series of processes is initiated when the management device 10 stops receiving such a signal requesting continuation of operation from an electronic control unit that finished implementing a corresponding specific function.

In step S30, the processing device 11 stops sending a message to an electronic control unit that finished implementing a corresponding specific function. When the electronic control unit no longer receives the message, the electronic control unit begins the shifting process for shifting to the standby state. Then, the electronic control unit completes the shifting process and shifts from the operation state to the standby state.

When the transmission of the message to the electronic control unit is stopped, the management device 10 ends the series of processes. In this manner, the management device 10 stops transmission of a message to an electronic control unit that finished implementing a corresponding specific function so that the electronic control unit shifts from the operation state to the standby state.

### Operation of the Present Embodiment

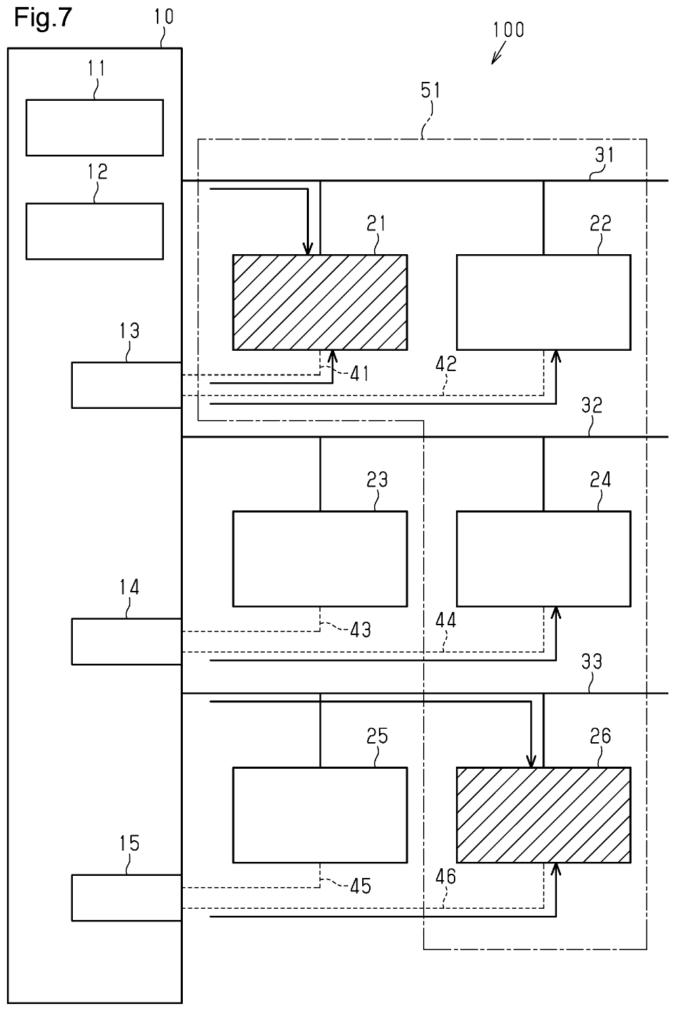

FIGS. 7 to 10 illustrate examples of the operation of the management device 10 obtained by executing the above-described processes. The operation of the management device 10 will now be described using four specific case examples, namely, a first case example, a second case example, a third case example, and a fourth case example.

FIG. 7 illustrates the first case example of a configuration in which the management device 10 supplies power to an electronic control unit and activates an electronic control unit. The first case example assumes a situation in which a request is received from a separate device. Specifically, the request is for a function that can be implemented by the electronic control units in the first cluster 61 when the vehicle is in the first state.

In the first case example, the vehicle is in the first state. As described with reference to FIG. 2, in the first state, the management device 10 supplies power to the electronic control units included in the first group 51, which are surrounded by the single-dashed lines.

As shown in FIG. 7, the management device 10 supplies power to the first ECU 21 included in the first group 51 through the first wire 41. As shown in FIG. 7, the management device 10 supplies power to the second ECU 22 included in the first group 51 through the second wire 42. As shown in FIG. 7, the management device 10 supplies power to the fourth ECU 24 included in the first group 51 through the fourth wire 44. As shown in FIG. 7, the management device 10 supplies power to the sixth ECU 26 included in the first group 51 through the sixth wire 46. In this manner, the first ECU 21, the second ECU 22, the fourth ECU 24, and the sixth ECU 26 are supplied with power and are thus shifted from the deactivation state to the standby state. In contrast, the third ECU 23 and the fifth ECU 25 are not supplied with power by the management device 10 and are thus in the deactivation state.

In the first case example, the management device 10 executes step S20 in FIG. 5 and determines that the electronic control units in the first cluster 61 are configured to implement the function requested by the separate device.

Then, the management device 10 executes step S21 in FIG. 5 and activates the electronic control units in the first cluster 61. Specifically, the management device 10 sends messages to the first ECU 21 through the first communication line 31 and to the sixth ECU 26 through the third communication line 33 so that the first ECU 21 and the sixth ECU 26 are shifted from the standby state to the operation state.

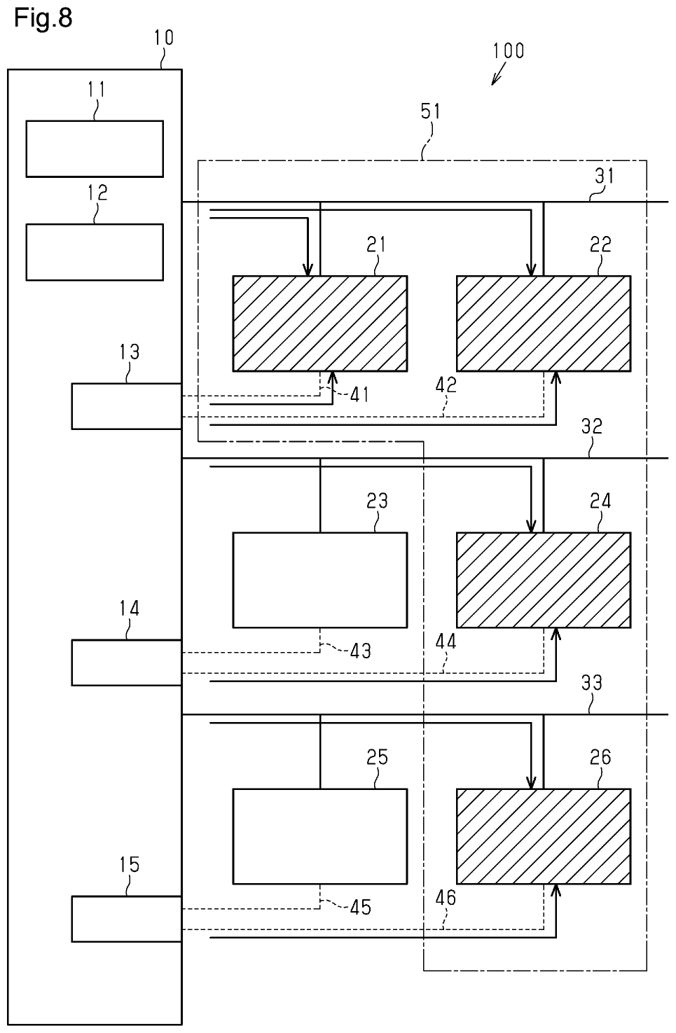

FIG. 8 illustrates the second case example of a configuration in which the management device 10 supplies power to an electronic control unit and activates an electronic control unit. The second case example assumes a situation in which a request is received from a separate device at a time point after the first case example and before the electronic control units in the first cluster 61 implement the corresponding specific function. Specifically, the request is for a function that can be implemented by the electronic control units in the second cluster 62 when the state of the vehicle remain the same. Accordingly, in the second case example, the vehicle is still in the first state as in the first case example.

In the second case example, the management device 10 executes step S20 in FIG. 5 and determines that the electronic control units in the second cluster 62 are configured to implement the function requested by the separate device.

Then, the management device 10 executes step S21 in FIG. 5 and activates the electronic control units in the second cluster 62. Specifically, the management device 10 sends messages to the second ECU 22 through the first communication line 31 and to the fourth ECU 24 through the second communication line 32 so that the second ECU 22 and the fourth ECU 24 are shifted from the standby state to the operation state.

In the second case example, the electronic control units in the first cluster 61 have not finished implementing the corresponding specific function. Thus, the management device 10 maintains the electronic control units in the first cluster 61 in the operation state by sending the messages through the first communication line 31 and the third communication line 33.

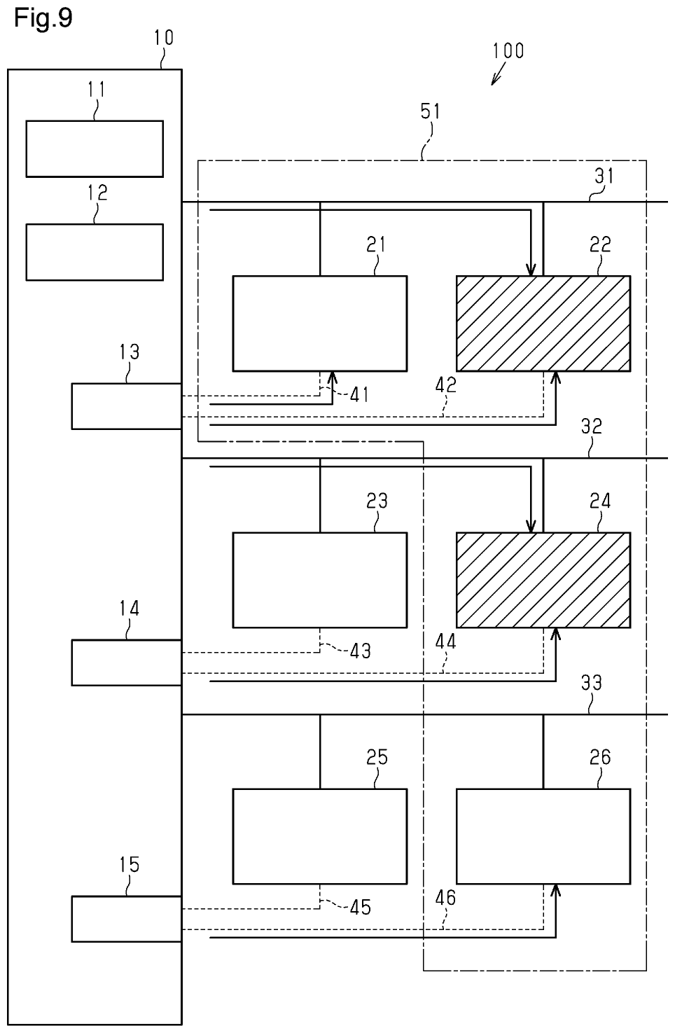

FIG. 9 illustrates the third case example of a configuration in which the management device 10 supplies power to an electronic control unit and activates an electronic control unit. The third case example assumes a situation in which the electronic control units in the first cluster 61 finishes implementing the corresponding specific function after the second case example and when the electronic control units in the second cluster 62 are implementing the corresponding specific function. Accordingly, in the third case example, the vehicle is still in the first state as in the second case example.

In the third case example, when the electronic control units in the first cluster 61 finish implementing the corresponding specific function, the electronic control units stop sending signals requesting continuation of operation. When the management device 10 no longer receives the signals requesting continuation of operation, the management device 10 executes step S30 in FIG. 6 and stops sending messages to the first ECU 21 and the sixth ECU 26 in the first cluster 61. Subsequently, the first ECU 21 and the sixth ECU 26 in the first cluster 61 execute the shifting process and shift from the operation state to the standby state.

In the third case example, the electronic control units in the second cluster 62 have not finished implementing the corresponding specific function. Thus, the management device 10 maintains the electronic control units in the second cluster 62 in the operation state by sending the messages through the first communication line 31 and the second communication line 32.

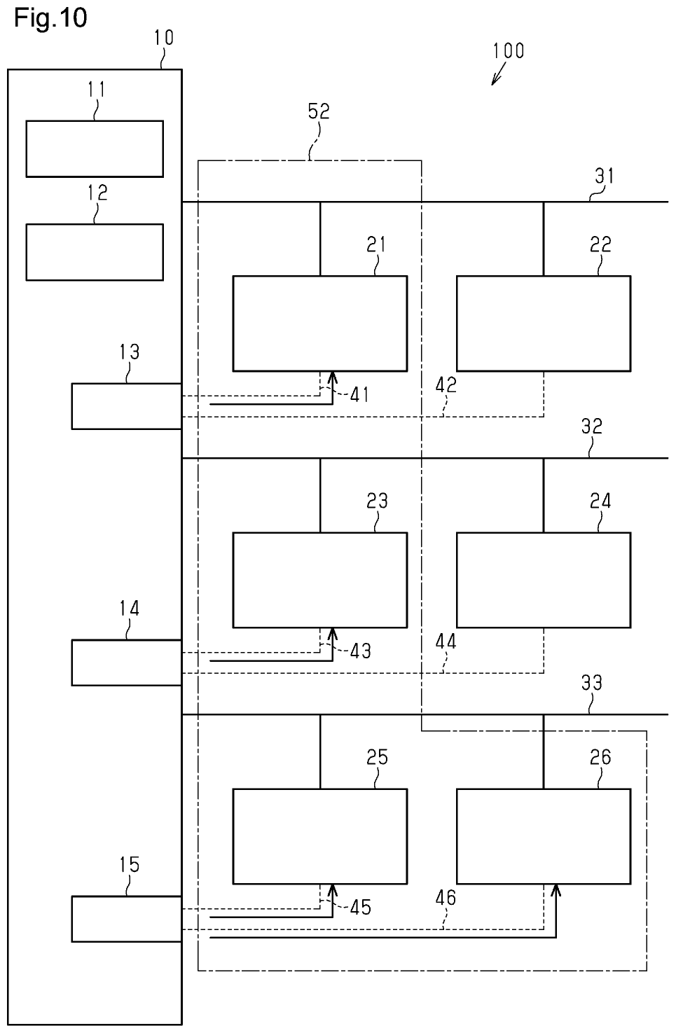

FIG. 10 illustrates the fourth case example of a configuration in which the management device 10 supplies power to an electronic control unit. The fourth case example assumes a situation in which the state of the vehicle is shifted from the first state to the second state at a time point after the third case example and before the electronic control units in the second cluster 62 finish implementing the corresponding specific function.

In the fourth case example, when the management device 10 detects that the state of the vehicle is shifted, the management device 10 executes step S10 in FIG. 4 and identifies that the vehicle is in the second state.

Next, the management device 10 executes step S11 in FIG. 4 and identifies a subject group to be supplied with power in accordance with the post-shifting state of the vehicle. As described with reference to FIG. 2, in the second state, the management device 10 supplies power to the electronic control units included in the second group 52.

Then, the management device 10 executes step S12 in FIG. 4. In the third case example, the electronic control units in the first cluster 61 were shifted to the standby state, and the electronic control units in the second cluster 62 were in the operation state. Thus, the management device 10 determines that there are electronic control units in the standby state and the operation state.

Subsequently, the management device 10 executes step S13 in FIG. 4. The second ECU 22 and the fourth ECU 24 were supplied with power in the third case example but not included in the second group 52. In the fourth case example, the vehicle is shifted to the second state before the electronic control units in the second cluster 62 finish implementing the corresponding specific function. Therefore, the management device 10 stops supplying power to the second ECU 22 and the fourth ECU 24 so that the second ECU 22 and the fourth ECU 24 are shifted from the operation state to the deactivation state. In contrast, the management device 10 continues to supply power to the first ECU 21 and the sixth ECU 26 that were shifted to the standby state.

Next, the management device 10 executes step S14 in FIG. 4 and supplies power to the electronic control units included in the second group 52. As shown in FIG. 10, the management device 10 supplies power to the third ECU 23 included in the second group 52 through the third wire 43. As shown in FIG. 10, the management device 10 supplies power to the fifth ECU 25 included in the second group 52 through the fifth wire 45. In this manner, the third ECU 23 and the fifth ECU 25 are supplied with power and are thus shifted from the deactivation state to the standby state. Further, the first ECU 21 and the sixth ECU 26 are continuously supplied with power and thus remain in the standby state. In contrast, the second ECU 22 and the fourth ECU 24 are no longer supplied with power by the management device 10 and are thus shifted to the deactivation state.

In this manner, the management device 10 deactivates a specific electronic control unit in accordance with the state of the vehicle.

### ADVANTAGES OF THE PRESENT EMBODIMENT

(1) The management device 10 shifts an electronic control unit from the standby state to the operation state by communicating with the electronic control unit. An electronic control unit may be shifted to the operation state under a condition in which the electronic control unit is in the standby state. Nonetheless, an electronic control unit in the standby state also consumes power. Thus, electric power consumption increases with the number of electronic control units in the standby state. The management device 10 reduces such consumption of power by the electronic control units in the standby state in the in-vehicle network system 100.
(2) The management device 10 is configured to selectively shift an electronic control unit to the standby state, in which the electronic control unit is supplied with power and is inactive, and the operation state, in which the electronic control unit is supplied with power and is permitted to perform processing.
(3) The management device 10 is connected to multiple electronic control units in a manner allowing for communication. The management device 10 is configured to shift an electronic control unit from the standby state to the operation state by communicating with the electronic control unit.
(4) When the state of the vehicle is the first state and the vehicle provides a first function, the management device 10 communicates with the electronic control units included in the first group 51. In this case, the management device 10 shifts the electronic control units in the first cluster 61 to the operation state. The electronic control units in the first cluster 61 are a combination of some of the electronic control units included in the first group 51. Further, the management device 10 shifts the electronic control units that are included in the first group 51 but not in the first cluster 61 to the standby state. When the state of the vehicle is the first state and the vehicle provides a second function that differs from the first function, the management device 10 communicates with the electronic control units included in the first group 51. In this case, the management device 10 shifts the electronic control units in the second cluster 62, which differs from the first cluster 61, to the operation state. The electronic control units in the second cluster 62 are a combination of some of the electronic control units included in the first group 51. Further, the management device 10 shifts the electronic control units that are included in the first group 51 but not in the second cluster 62 to the standby state.

When the vehicle is in the first state, the electronic control units included in the first group 51 are supplied with power. Thus, each electronic control unit included in the first group 51 is in the standby state and may be shifted to the operation state. When the vehicle is in the first state, the management device 10 identifies ones of the electronic control units included in the first group 51 that are in a cluster, which corresponds to a function to be provided by the vehicle. Then, the management device 10 shifts such electronic control units to the operation state. In this manner, when the vehicle provides a specific function, the management device 10 readily activates the electronic control units that implement the specific function.
(5) Each cluster includes electronic control units that shift to the operation state so that a corresponding specific function is provided. The first group 51 includes the clusters respectively corresponding to the specific functions having a likelihood of being provided by the vehicle in the first state. The management device 10 supplies power to only the electronic control units related to the functions having a likelihood of being provided by the vehicle in the first state. In contrast, the first group 51 includes no cluster corresponding to a specific function that will not be provided by the vehicle in the first state. In this manner, the management device 10 minimizes the number of electronic control units supplied with power while ensuring every electronic control unit that may be activated in the first state is supplied with power. Thus, the management device 10 efficiently reduces consumption of power by the electronic control units in the standby state in the in-vehicle network system 100.
(6) Each cluster includes electronic control units that shift to the operation state so that a corresponding specific function is provided. Each group includes clusters respectively corresponding to specific functions having a likelihood of being provided by the vehicle in a state corresponding to the group. Accordingly, the management device 10 supplies power to only electronic control units related to functions having a likelihood of being provided by the vehicle in a corresponding state, not limited to the first state. In this manner, the management device 10 minimizes the number of electronic control units supplied with power while ensuring every electronic control unit that may be activated in the present state is supplied with power. Thus, the management device 10 efficiently reduces consumption of power by the electronic control units in the standby state in the in-vehicle network system 100.
(7) As the vehicle finishes providing a specific function, the management device 10 shifts the electronic control units in a cluster corresponding to the function from the operation state to the standby state. As the vehicle finishes providing a specific function, the management device 10 shifts the electronic control units in a cluster corresponding to the service from the operation state to the standby state. In this manner, the management device 10 reduces consumption of power by the electronic control units in the cluster corresponding to the function that was finished.
(8) As the state of the vehicle is shifted, the management device 10 stops supplying power to electronic control units that are included in a group corresponding to the pre-shifting state of the vehicle and are not included in a group corresponding to the post-shifting state of the vehicle. As the state of the vehicle is shifted, the management device 10 immediately stops supplying power to electronic control units that will not be operating in the post-shifting state. In this manner, the management device 10 reduces electric power consumption of the in-vehicle network system 100.
(9) When the state of the vehicle is the second state and the vehicle provides a third function, the management device 10 communicates with the electronic control units included in the second group 52. In this case, the management device 10 shifts the electronic control units in the third cluster 63 to the operation state. The electronic control units in the third cluster 63 are a combination of some of the electronic control units included in the second group 52. Further, the management device 10 shifts the electronic control units that are included in the second group 52 but not in the third cluster 63 to the standby state. When the state of the vehicle is the second state and the vehicle provides a fourth function that differs from the third function, the management device 10 communicates with the electronic control units included in the second group 52. In this case, the management device 10 shifts the electronic control units in the fourth cluster 64, which differs from the third cluster 63, to the operation state. The electronic control units in the fourth cluster 64 are a combination of some of the electronic control units included in the second group 52. Further, the management device 10 shifts the electronic control units that are included in the second group 52 but not in the fourth cluster 64 to the standby state.

When the vehicle is in the second state, the electronic control units included in the second group 52 are supplied with power. Thus, each electronic control unit included in the second group 52 is in the standby state and may be shifted to the operation state. When the vehicle is in the second state, the management device 10 identifies ones of the electronic control units included in the second group 52 that are in a cluster, which corresponds to a function to be provided by the vehicle. Then, the management device 10 shifts such electronic control units to the operation state. In this manner, when the vehicle provides a specific function, the management device 10 readily activates the electronic control units that implement the specific function.
(10) The first state is a state in which the vehicle is being charged and is at a standstill, and the second state is a state in which the vehicle is not being charged and is at a standstill. When the vehicle is at a standstill, the functions having a likelihood of being provided by the vehicle differ between a state in which the vehicle is being charged and a state in which the vehicle is not being charged. Accordingly, as long as different groups are assigned to electronic control units that are supplied with power when the vehicle is at a standstill and being charged and electronic control units that are supplied with power when the vehicle is at a standstill and not being charged, as described above, the management device 10 efficiently supplies power to the electronic control units.
(11) In the in-vehicle network system 100, which is a network system for a vehicle including multiple electronic control units, the storage device 12 of the management device 10 stores the control program. When the state of the vehicle is the first state, the control program causes the management device 10 to supply power to an electronic control unit included in the first group 51, which is one of the groups each including at least one electronic control unit. Further, when the state of the vehicle is the first state, the control program causes the management device 10 to not supply power to an electronic control unit not included in the first group 51. When the state of the vehicle is the second state, which differs from the first state, the control program causes the management device 10 to supply power to an electronic control unit included in the second group 52, which differs from the first group 51. Further, when the state of the vehicle is the second state, the control program causes the management device 10 to not supply power to an electronic control unit not included in the second group 52.

The control program deactivates a specific electronic control unit in accordance with the state of the vehicle. In this manner, the control program reduces consumption of power by the electronic control units in the standby state in the in-vehicle network system 100.
(12) The control program is executed by the management device 10 that is configured to selectively shift an electronic control unit to the standby state, in which the electronic control unit is supplied with power and is inactive, and the operation state, in which the electronic control unit is supplied with power and is permitted to perform processing.
(13) The control program is executed by the management device 10 that is connected to multiple electronic control units in a manner allowing for communication and is configured to shift an electronic control unit from the standby state to the operation state by communicating with the electronic control unit.
(14) When the state of the vehicle is the first state and the vehicle provides the first function, the control program causes the management device 10 to communicate with the electronic control units included in the first group 51. In this case, the control program causes the management device 10 to shift the electronic control units in the first cluster 61 to the operation state. The electronic control units in the first cluster 61 are a combination of some of the electronic control units included in the first group 51. Further, the control program causes the management device 10 to shift the electronic control units that are included in the first group 51 but not in the first cluster 61 to the standby state. When the state of the vehicle is the first state and the vehicle provides the second function that differs from the first function, the control program causes the management device 10 to communicate with the electronic control units included in the first group 51. In this case, the control program causes the management device 10 to shift the electronic control units in the second cluster 62, which differs from the first cluster 61, to the operation state. The electronic control units in the second cluster 62 are a combination of some of the electronic control units included in the first group 51. Further, the control program causes the management device 10 to shift the electronic control units that are included in the first group 51 but not in the second cluster 62 to the standby state.

When the vehicle is in the first state, the electronic control units included in the first group 51 are supplied with power. Thus, each electronic control unit included in the first group 51 is in the standby state and may be shifted to the operation state. When the vehicle is in the first state, the control program is executed so that ones of the electronic control units included in the first group 51 that are in a cluster, which corresponds to a function to be provided by the vehicle, are identified. Then, such electronic control units are shifted to the operation state. In this manner, when the vehicle provides a specific function, the control program readily activates the electronic control units that implement the specific function.
(15) A control method is provided for controlling the in-vehicle network system 100, which is a network system for a vehicle including multiple electronic control units. The control method includes a first step and a second step. In the first step, when the state of the vehicle is the first state, the management device 10 of the in-vehicle network system 100 supplies power to an electronic control unit included in the first group 51. The first group 51 is one of the groups, each including at least one electronic control unit. Further, in the first step, when the vehicle is in the first state, the management device 10 does not supply power to an electronic control unit not included in the first group 51. In the second step, when the state of the vehicle is the second state, which differs from the first state, the management device 10 supplies power to an electronic control unit included in the second group 52, which differs from the first group 51. Further, in the second step, the management device 10 does not supply power to an electronic control unit not included in the second group 52. The above control method deactivates a specific electronic control unit in accordance with the state of the vehicle. In this manner, the control method reduces consumption of power by the electronic control units in the standby state in the in-vehicle network system 100.
(16) In accordance with the control method, the first and second steps are performed by the management device 10 that is configured to selectively shift an electronic control unit to the standby state, in which the electronic control unit is supplied with power and is inactive, and the operation state, in which the electronic control unit is supplied with power and is permitted to perform processing.
(17) In accordance with the control program, the first and second steps are performed by the management device 10 that is connected to multiple electronic control units in a manner allowing for communication and is configured to shift an electronic control unit from the standby state to the operation state by communicating with the electronic control unit.
(18) The control method includes a third step and a fourth step. In the third step, when the state of the vehicle is the first state and the vehicle provides the first function, the management device 10 communicates with the electronic control units included in the first group 51. In this case, the management device 10 shifts the electronic control units in the first cluster 61 to the operation state. The electronic control units in the first cluster 61 are a combination of some of the electronic control units included in the first group 51. Further, the management device 10 shifts the electronic control units that are included in the first group 51 but not in the first cluster 61 to the standby state. In the fourth step, when the state of the vehicle is the first state and the vehicle provides the second function that differs from the first function, the management device 10 communicates with the electronic control units included in the first group 51. In this case, the management device 10 shifts the electronic control units in the second cluster 62, which differs from the first cluster 61, to the operation state. The electronic control units in the second cluster 62 are a combination of some of the electronic control units included in the first group 51. Further, the management device 10 shifts the electronic control units that are included in the first group 51 but not in the second cluster 62 to the standby state.

When the vehicle is in the first state, the electronic control units included in the first group 51 are supplied with power. Thus, each electronic control unit included in the first group 51 is in the standby state and may be shifted to the operation state. When the vehicle is in the first state, the control method is performed so that ones of the electronic control units included in the first group 51 that are in a cluster, which corresponds to a function to be provided by the vehicle, are identified. Then, such electronic control units are shifted to the operation state. In this manner, when the vehicle provides a specific function, the control method readily activates the electronic control units that implement the specific function.

### MODIFIED EXAMPLES

The above embodiment may be modified as described below. The above embodiment and the following modifications can be combined as long as the combined modifications remain technically consistent with each other.

In the above embodiment, the management device 10 is connected to each electronic control unit by a different wire. Alternatively, the management device 10 may be connected to multiple electronic control units by a single wire.

In the above embodiment, a group includes electronic control units that are connected to different communication lines. Alternatively, a group may include multiple electronic control units that are connected to the same communication line.

In the above embodiment, each group includes a cluster that implements a specific function having a likelihood of being provided by the vehicle under a condition corresponding to the group. Accordingly, each group only includes electronic control units that are related to the specific function having a likelihood of being provided by the vehicle under the condition corresponding to the group. Alternatively, each group may include an electronic control unit that is irrelevant to the specific function having a likelihood of being provided by the vehicle under the condition corresponding to the group.

In the above embodiment, the management device 10 exchanges messages with an electronic control unit through a corresponding communication line. Alternatively, the management device 10 may be connected to an electronic control unit in a manner allowing for wireless communication and exchange messages through wireless communication.

In this case, the management device 10 does not control the supply of power to an electronic control unit that is unable to perform wireless communication with the management device 10. Thus, the electronic control unit that is unable to perform wireless communication with the management device 10 will not be identified as the subject to be supplied with power by the management device 10. In other words, the electronic control unit that is unable to perform wireless communication with the management device 10 is excluded from the groups that receive power from the management device 10.

In the above embodiment, the management device 10 determines the state of the vehicle in step S10 of FIG. 4. Alternatively, the management device 10 may obtain information indicating the state of the vehicle from another device that identifies the state of the vehicle.

In the above embodiment, the state of the vehicle includes two states, namely, the first state and the second state. However, there is no limit to such a configuration, and the state of the vehicle may include more than two states.

In the above embodiment, as long as the management device 10 receives a signal requesting continuation of operation from an active electronic control unit, the management device 10 sends a message to the electronic control unit. When the electronic control unit stops receiving the message addressed to the subject electronic control unit from the management device 10, the electronic control unit stops operating and shifts to the standby state. Alternatively, after activating an electronic control unit, the management device 10 may be configured to not send a message to the electronic control unit even when a signal requesting continuation of operation is received. In this case, the electronic control unit in the operation state continues to operate for a certain period of time whenever the electronic control unit receives a signal requesting continuation of operation from another electronic control unit in the same cluster. When the electronic control unit stops receiving the signal requesting continuation of operation from the other electronic control unit in the same cluster, the electronic control unit stops operating and shifts to the standby state.

In the above embodiment, the first group 51 and the second group 52 each include two clusters. Alternatively, each of the groups may include three or more clusters.

In the above embodiment, the second group 52 includes two clusters, namely, the third cluster 63 and the fourth cluster 64. Alternatively, the second group 52 may include only one cluster, unlike the first group 51. In this case, the management device 10 activates all of the electronic control units included in the second group 52 at the same time.

In the above embodiment, as the state of the vehicle is shifted, the management device 10 performs step S13 of FIG. 4 and immediately stops the supply of power to an electronic control unit even if the electronic control unit is in the operation state. In other words, in the above embodiment, the management device 10 stops the supply of power to an electronic control unit that has not completed the shifting process without having the electronic control unit complete the shifting process. Instead of immediately shifting an electronic control unit that has not completed the shifting process to the deactivation state as the state of the vehicle is shifted, the management device 10 may be configured to stop the supply of power after the electronic control unit completes the shifting process and shifts to the standby state.

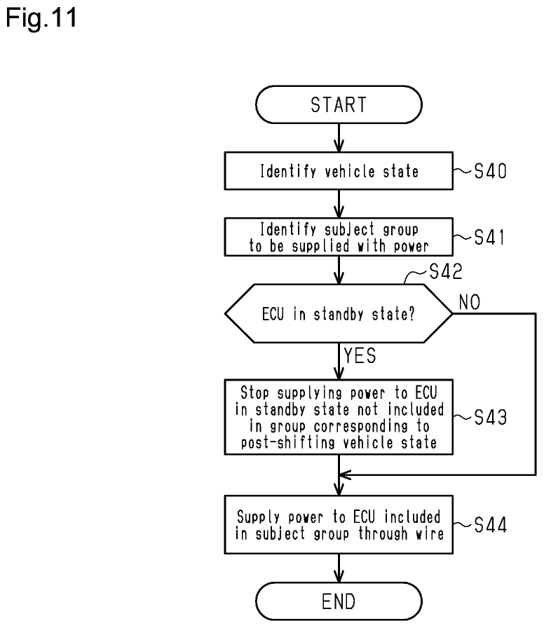

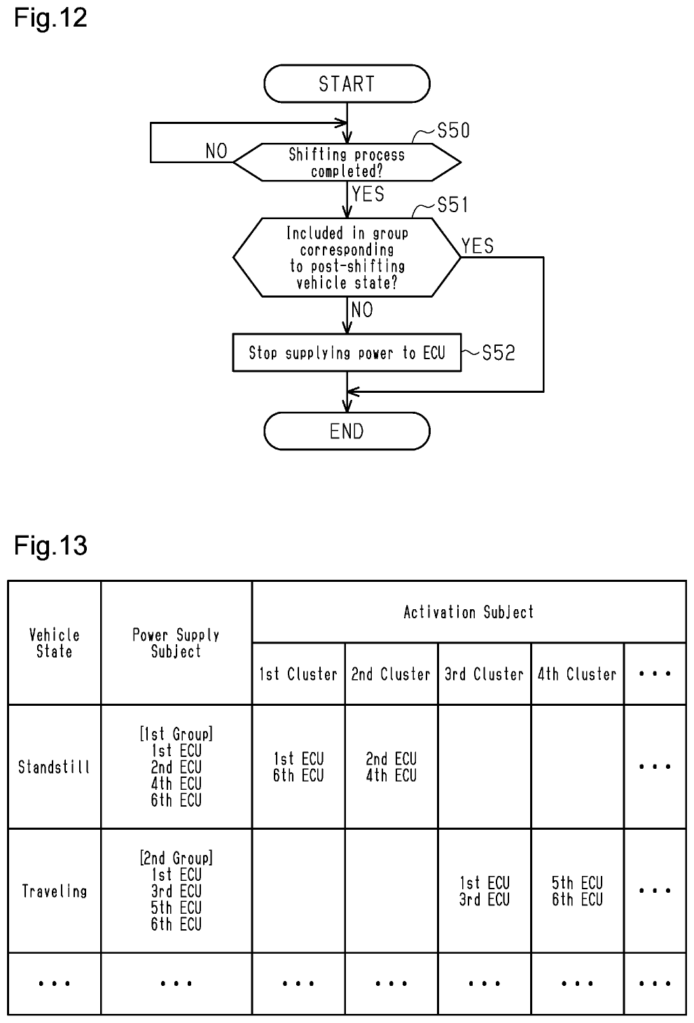

FIGS. 11 and 12 show processes executed by the management device 10 in accordance with the above modified example.

The processes shown in FIG. 11 substitute the processes shown in FIG. 4 of the above embodiment. Steps S40 and S41 in FIG. 11 are the same as steps S10 and S11.

In step S42, the processing device 11 determines whether there is an electronic control unit in the standby state in the in-vehicle network system 100.

When the processing device 11 determines that there is an electronic control unit in the standby state in-vehicle network system 100 in step S42 (step S42: YES), the processing device 11 proceeds to step S43. In step S43, the processing device 11 stops supplying power to an electronic control unit. Specifically, the processing device 11 stops supplying power to an electronic control unit that is included in a group corresponding to the pre-shifting state of the vehicle, not included in a group corresponding to the post-shifting state of the vehicle, and is in the standby state. When the supply of power to such an electronic control unit is stopped, the electronic control unit shifts from the standby state to the deactivation state. After completing step S43, the processing device 11 proceeds to step S44.

When the processing device 11 determines that there is no electronic control unit in the standby state in-vehicle network system 100 in step S42 (step S42: NO), the processing device 11 proceeds to step S44. That is, when the processing device 11 determines that no electronic control unit is in the standby state in the in-vehicle network system 100, the processing device 11 skips step S43.

A situation in which there is no electronic control unit in the standby state in the in-vehicle network system 100 may include two situations. For one situation, every electronic control unit included in the group that corresponds to the pre-shifting state of the vehicle is in the operation state. In another situation, no subject group was supplied with power in the pre-shifting state of the vehicle.

The following step S44 is the same as step S14 in FIG. 4. After step S44, the management device 10 ends the series of processes shown in FIG. 11.

The series of processes shown in FIG. 11 differs from the series of processes shown in FIG. 4 in that the management device 10 does not stop supplying power to an electronic control unit that was in the operation state in the pre-shifting state of the vehicle.

FIG. 12 shows a series of processes executed on an electronic control unit that is in the operation state when the state of the vehicle is shifted. The present series of processes is initiated when the management device 10 detects that the state of the vehicle is shifted, in the same manner as the processes shown in FIGS. 4 and 11.

When the state of the vehicle is shifted, an electronic control unit that is in the operation state stops implementing the corresponding specific function. Then, the electronic control unit in the operating state executes the shifting process following step S30 in FIG. 5.

In step S50, the processing device 11 determines whether the electronic control unit has completed the shifting process. As described above, an electronic control unit sends a signal indicating that the electronic control unit is executing the shifting process until the shifting process is completed. Accordingly, the processing device 11 determines that the electronic control unit has completed the shifting process when the processing device 11 stops receiving a signal indicating that the shifting process is being executed from the electronic control unit.

When the processing device 11 determines that the electronic control unit has not completed the shifting process in step S50 (step S50: NO), the processing device 11 repeats step S50. When the processing device 11 determines that the electronic control unit has completed the shifting process in step S50 (step S50: YES), the processing device 11 proceeds to step S51.

In step S51, the processing device 11 determines whether the electronic control unit that has completed the shifting process is included in a group corresponding to the post- shifting state of the vehicle.

When the processing device 11 determines that the electronic control unit, which has completed the shifting process, is not included in a group corresponding to the post- shifting state of the vehicle in step S51 (step S51: NO), the processing device 11 proceeds to step S52. In step S52, the processing device 11 stops supplying power to the electronic control unit that has completed the shifting process. In other words, when an electronic control unit that has completed the shifting process is not included in a group corresponding to the post-shifting state of the vehicle, the processing device 11 stops supplying power to the electronic control unit. After stopping the supply of power to the electronic control unit, the processing device 11 ends the series of processes shown in FIG. 12.

When the processing device 11 determines that the electronic control unit, which has completed the shifting process, is included in a group corresponding to the post-shifting state of the vehicle in step S51 (step S51: YES), the processing device 11 ends the series of processes shown in FIG. 12. In other words, when an electronic control unit that has completed the shifting process is included in a group corresponding to the post-shifting state of the vehicle, the processing device 11 ends the series of processes shown in FIG. 12 while maintaining the supply of power to the electronic control unit.

As the state of the vehicle is shifted, if any of the electronic control units, included in a group corresponding to the pre-shifting state of the vehicle and not included in a group corresponding to the post-shifting state of the vehicle, has not completed the shifting process, the management device 10 waits until the electronic control unit completes the shifting process and shifts to the standby state. Then, the management device 10 stops supplying power to the electronic control unit. If the supply of power to such an electronic control unit is stopped before the shifting process is completed, data will not be stored in a memory. This may cause inconvenience; for example, the data cannot be used in a subsequent control executed on the electronic control unit. As the state of the vehicle is shifted, the management device 10 waits until an electronic control unit that has not completed the shifting process completes the shifting process, and then stops supplying power to the electronic control unit. In this manner, the management device 10 avoids occurrence of inconvenience in a subsequent control executed on the electronic control unit by having the electronic control unit complete the shifting process.

In the above embodiment, the first state is a state in which the vehicle is being charged and is at a standstill, and the second state is a state in which the vehicle is not being charged and is at a standstill. Alternatively, as shown in FIG. 13, the first state may be a state in which the vehicle is at a standstill, and the second state may be a state in which the vehicle is traveling. The functions having a likelihood of being provided by the vehicle differ between the stopped state and the traveling state. Accordingly, as long as different groups are assigned to electronic control units that are supplied with power when the vehicle is at a standstill and electronic control units that are supplied with power when the vehicle is traveling, in the same manner as described above, the management device 10 efficiently supplies power to the electronic control units.

In the above embodiment, the management device 10 includes a central processing unit (CPU), a random-access memory (RAM), and a read-only memory (ROM). The management device 10 performs software processing. However, such a configuration is merely an example. In another example, the management device 10 may include a dedicated hardware circuit (such as application specific integrated circuit, ASIC) that executes at least part of the software processing performed in the above embodiment. More specifically, the management devices 10 may have any one of the following configurations (a) to (c). (a) The management device 10 includes a processor that executes all processes according to programs and a program storage device, such as a ROM, that stores the programs. That is, the management device 10 includes a software execution device. (b) The management device 10 includes a processor that executes part of processes according to programs and a program storage device. The management devices 10 further includes a dedicated hardware circuit that executes the remaining processes. (c) The management device 10 includes a dedicated hardware circuit that executes all processes. There may be more than one software execution device and/or more than one dedicated hardware circuit. Specifically, the above-described processes may be executed by processing circuitry including at least one of a software execution device and a dedicated hardware circuit. The processing circuitry may include more than one software execution device and/or more than one dedicated hardware circuit. The program storage device, or a non-transitory computer readable storage medium, includes any available medium that is accessible by a general-purpose computer or a dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A management device, wherein:
the management device is of a network system for a vehicle, the network system including electronic control units that form groups, the groups each including at least one of the electronic control units, the groups including a first group and a second group, the first group differing from the second group;
when a state of the vehicle is a first state, the management device is configured to supply power to the at least one of the electronic control units included in the first group, and not supply power to one or more of the electronic control units not included in the first group; and
when the state of the vehicle is a second state differing from the first state, the management device is configured to supply power to the at least one of the electronic control units included in the second group, and not supply power to one or more of the electronic control units not included in the second group.

2. The management device according to claim 1, wherein:
the management device is further configured to selectively shift a first electronic control unit of the electronic control units to a standby state and an operation state;
when the first electronic control unit is in the standby state, the first electronic control unit is supplied with power and is inactive; and
when the first electronic control unit is in the operation state, the first electronic control unit is supplied with power and is permitted to perform processing.

3. The management device according to claim 2, wherein:
the management device is connected to the electronic control units in a manner allowing for communication; and
the management device is further configured to shift the first electronic control unit from the standby state to the operation state by communicating with the first electronic control unit.

4. The management device according to claim 3, wherein:
the at least one of the electronic control units included in the first group includes three or more of the electronic control units, and a combination of at least two of the at least one of the electronic control units included in the first group forms a first cluster;
when the state of the vehicle is the first state and the vehicle provides a first function, the management device is configured to shift the at least two of the electronic control units in the first cluster to the operation state through communication, and shift any one of the electronic control units that is included in the first group but not in the first cluster to the standby state through communication;
a combination of at least two of the at least one of the electronic control units included in the first group forms a second cluster, the first cluster differing from the second cluster; and
when the state of the vehicle is the first state and the vehicle provides a second function differing from the first function, the management device is configured to shift the at least two of the electronic control units in the second cluster to the operation state through communication, and shift any one of the electronic control units that is included in the first group but not in the second cluster to the standby state through communication.

5. The management device according to claim 4, wherein:
the first group includes clusters respectively corresponding to functions having a likelihood of being provided by the vehicle in the first state, the clusters including the first cluster and the second cluster;
the at least two of the electronic control units in the first cluster shift to the operation state so that the vehicle provides the first function; and
the at least two of the electronic control units in the second cluster shift to the operation state so that the vehicle provides the second function.

6. The management device according to claim 4, wherein, as the vehicle finishes providing the first function, the management device is configured to shift the at least two of the electronic control units in the first cluster from the operation state to the standby state.

7. The management device according to claim 4, wherein, as the state of the vehicle is shifted, the management device is configured to stop supplying power to any of the electronic control units that is included in one of the groups corresponding to a pre-shifting state of the vehicle and is not included in another one of the groups corresponding to a post-shifting state of the vehicle.

8. The management device according to claim 4, wherein:
as the state of the vehicle is shifted, if any of the electronic control units, included in one of the groups corresponding to a pre-shifting state of the vehicle and not included in another one of the groups corresponding to a post-shifting state of the vehicle, has not completed a shifting process, the shifting process being executed for shifting from the operation state to the standby state, the management device is configured to wait until the any of the electronic control units completes the shifting process and shifts to the standby state; and
after the any of the electronic control units completes the shifting process and shifts to the standby state, the management device is configured to stop supplying power to the any of the electronic control units.

9. The management device according to claim 4, wherein:
the at least one of the electronic control units included in the second group includes three or more of the electronic control units, and a combination of at least two of the at least one of the electronic control units included in the second group forms a third cluster;
when the state of the vehicle is the second state and the vehicle provides a third function, the management device is configured to shift the at least two of the electronic control units in the third cluster to the operation state through communication, and shift any one of the electronic control units that is included in the second group but not in the third cluster to the standby state through communication;
a combination of at least two of the at least one of the electronic control units included in the second group forms a fourth cluster, the fourth cluster differing from the third cluster; and
when the state of the vehicle is the second state and the vehicle provides a fourth function differing from the third function, the management device is configured to shift the at least two of the electronic control units in the fourth cluster to the operation state through communication, and shift any one of the electronic control units that is included in the second group but not in the fourth cluster to the standby state through communication.

10. The management device according to claim 1, wherein
the first state is a state in which the vehicle is being charged and is at a standstill, and
the second state is a state in which the vehicle is not being charged and is at a standstill.

11. The management device according to claim 1, wherein
the first state is a state in which the vehicle is at a standstill, and
the second state is a state in which the vehicle is traveling.

12. A non-transitory computer readable storage medium storing a control program, wherein:
the control program is configured to be executed by a management device of a network system for a vehicle, the network system including electronic control units that form groups, the groups each including at least one of the electronic control units, the groups including a first group and a second group, the first group differing from the second group;
when a state of the vehicle is a first state, the control program executed by the management device is configured to cause the management device to supply power to the at least one of the electronic control units included in the first group, and not supply power to one or more of the electronic control units not included in the first group; and
when the state of the vehicle is a second state differing from the first state, the control program executed by the management device is configured to cause the management device to supply power to the at least one of the electronic control units included in the second group, and not supply power to one or more of the electronic control units not included in the second group.

13. The non-transitory computer readable storage medium according to claim 12, wherein:
the control program is further configured to cause the management device to selectively shift a first electronic control unit of the electronic control units to a standby state and an operation state;
when the first electronic control unit is in the standby state, the first electronic control unit is supplied with power and is inactive; and
when the first electronic control unit is in the operation state, the first electronic control unit is supplied with power and is permitted to perform processing.

14. The non-transitory computer readable storage medium according to claim 13, wherein:
the management device is connected to the electronic control units in a manner allowing for communication; and
the control program is further configured to cause the management device to shift the first electronic control unit from the standby state to the operation state by communicating with the first electronic control unit.

15. The non-transitory computer readable storage medium according to claim 14, wherein:
the at least one of the electronic control units included in the first group includes three or more of the electronic control units, and a combination of at least two of the at least one of the electronic control units included in the first group forms a first cluster;
when the state of the vehicle is the first state and the vehicle provides a first function, the control program is configured to cause the management device to shift the at least two of the electronic control units in the first cluster to the operation state through communication, and shift any one of the electronic control units that is included in the first group but not in the first cluster to the standby state through communication;
a combination of at least two of the at least one of the electronic control units included in the first group forms a second cluster, the first cluster differing from the second cluster; and
when the state of the vehicle is the first state and the vehicle provides a second function differing from the first function, the control program is configured to cause the management device to shift the at least two of the electronic control units in the second cluster to the operation state through communication, and shift any one of the electronic control units that is included in the first group but not in the second cluster to the standby state through communication.

16. A control method for controlling a network system for a vehicle, the network system including electronic control units that form groups, the groups each including at least one of the electronic control units, the groups including a first group and a second group, the first group differing from the second group,
when a state of the vehicle is a first state, the control method comprising:
supplying power, with a management device of the network system, to the at least one of the electronic control units included in the first group, and
not supplying power, with the management device, to one or more of the electronic control units not included in the first group; and
when the state of the vehicle is a second state differing from the first state, the control method comprising:
supplying power, with the management device, to the at least one of the electronic control units included in the second group, and
not supplying power, with the management device, to one or more of the electronic control units not included in the second group.

17. The control method according to claim 16, further comprising:
selectively shifting, with the management device, a first electronic control unit of the electronic control units to a standby state and an operation state, wherein:
when the first electronic control unit is in the standby state, the first electronic control unit is supplied with power and is inactive; and
when the first electronic control unit is in the operation state, the first electronic control unit is supplied with power and is permitted to perform processing.

18. The control method according to claim 17, wherein, the management device is connected to the electronic control units in a manner allowing for communication, the control method further comprising:
shifting, with the management device, the first electronic control unit from the standby state to the operation state by communicating with the first electronic control unit.

19. The control method according to claim 18, wherein:
the at least one of the electronic control units included in the first group includes three or more of the electronic control units, and a combination of at least two of the at least one of the electronic control units included in the first group forms a first cluster,
when the state of the vehicle is the first state and the vehicle provides a first function, the control method further comprising:
shifting, with the management device, the at least two of the electronic control units in the first cluster to the operation state through communication, and
shifting, with the management device, any one of the electronic control units that is included in the first group but not in the first cluster to the standby state through communication; and
a combination of at least two of the at least one of the electronic control units included in the first group forms a second cluster, the first cluster differing from the second cluster,
when the state of the vehicle is the first state and the vehicle provides a second function differing from the first function, the control method further comprising:
shifting, with the management device, the at least two of the electronic control units in the second cluster to the operation state through communication, and
shifting, with the management device, any one of the electronic control units that is included in the first group but not in the second cluster to the standby state through communication.
